(19) United States
(12) Patent Application Publication
(10) Pub. No.: US 2021/0218675 A1
(43) Pub. Date: Jul. 15, 2021

(54) METHODS AND NODES FOR DELIVERING DATA CONTENT

(71) Applicant: TELEFONAKTIEBOLAGET LM ERICSSON (PUBL), Stockholm (SE)

(72) Inventors: Hans HANNU, LULEÅ (SE); Ingemar JOHANSSON, LULEÅ (SE)

(21) Appl. No.: 17/267,950

(22) PCT Filed: Sep. 18, 2018
(86) PCT No.: PCT/SE2018/050954

§ 371 Date: Feb. 11, 2021

(51) Int. Cl. H04L 12/801; H04L 12/803; H04L 12/851; H04L 12/26

(52) U.S. Cl. CPC H04L 47/11; H04L 47/14; H04L 43/16; H04L 47/2441; H04L 47/125

(57) ABSTRACT

A method for delivering data content in a communication network from a first node to a second node, the method comprising at the first node: sending a first portion of data of the data content to the second node; obtaining an indication that a network congestion criteria is fulfilled, said indication being based on a comparison of a network load estimate to a load threshold; and sending a second portion of data of the data content to the second node, wherein the first portion of data is sent using a first congestion control type and the second portion of data is sent using a second congestion control type.

### TECHNICAL FIELD

The proposed technology relates to methods and nodes for delivering data content in a communication network from a first node to a second node. Furthermore, computer programs, computer program products, and carriers are also provided herein.

### BACKGROUND

The volume of data traffic sent in communication networks is increasing rapidly. One major contributor is today's huge number of network services available to content consumption, such as video streaming, social networking, gaming, etc. The limited network resources should be used optimally to provide user satisfaction, both in form of Quality of Service (QoS) and in form of Quality of Experience (QoE).

For this purpose, data traffic may be divided into two categories: foreground traffic and background traffic. Foreground traffic may be characterized by a sensitivity to delays in the transmission. For example, a voice call subject to delays in the sending and receiving of data is immediately perceived as poor-quality transmission by the persons involved in the call. Similarly, when using services such as, e.g., video streaming, gaming and web browsing, the network appears sluggish when not enough resources are provided for the data transmission and has a direct effect on the quality of the service. Traffic which is relatively insensitive to delays may thus be considered as background traffic. For example, data content that is not immediately used, or consumed, upon its reception at the receiving point is generally not sensitive to transmission delays. As an example, uploading a data file of reasonably large size to a server is expected to take some time, and any delays, if not overly excessive, do not affect the perceived quality of the transmission. In yet other examples, the time of delivery of a data file is unknown and hence the delivery process may not be monitored at all by a user. Thus, background traffic may be traffic associated with uploading or downloading data content, or data files, e.g. for later use, such as prefetching of a video, delivery of bulk data files, and the like.

Ideally, background traffic is transmitted when the network load is low, to minimize the risk of occupying resources needed to deliver the foreground traffic without unacceptable delays. However, the operator of the network may not always have the possibility to report network load to a user or a node using the network, and there is no easy way to determine the network load to find an appropriate time to deliver data content.

### SUMMARY

It is an object of the present disclosure to provide methods and nodes for solving or at least alleviating, at least some of the problems described above.

This and other objects are met by embodiments of the proposed technology.

According to a first aspect, there is provided a method for delivering data content in a communication network from a first node to a second node. The method comprises the following steps at the first node. The first node sends a first portion of data of the data content to the second node. The first node obtains an indication that a network congestion criteria is fulfilled, said indication being based on a comparison of a network load estimate to a load threshold. In the method the first node also sends a second portion of data of the data content to the second node. In this method, the first portion of data is sent using a first congestion control type and the second portion of data is sent using a second congestion control type.

According to a second aspect, there is provided a first node for sending data content in a communication network. The first node is configured to send a first portion of data of the data content to a second node. The first node is further configured to obtain an indication that a network congestion criteria is fulfilled, said indication being based on a comparison of a network load estimate to a load threshold. The first node is also configured to send a second portion of data of the data content to the second node. The first portion of data is sent using a first congestion control type and the second portion of data is sent using a second congestion control type.

According to a third aspect, there is provided a method for delivering data content in a communication network from a first node to a second node, the method comprising the following steps at the second node. The second node receives a first portion of data of the data content from the first node. The second node also obtains an indication that a network congestion criteria is fulfilled, said indication being based on a comparison of a network load estimate to a load threshold. In the method the second node also sends the indication to the first node, and receives a second portion of data of the data content from the first node. The first portion of data is sent using a first congestion control type and the second portion of data is sent using a second congestion control type.

According to a fourth aspect, there is provided a second node for receiving data content in a communication network. The second node is configured to receive a first portion of data of the data content from a first node. The second node is further configured to obtain an indication that a network congestion criteria is fulfilled, said indication being based on a comparison of a network load estimate to a load threshold. The second node is also configured to send the indication to the first node, and also to receive a second portion of data of the data content from the first node. The first portion of data is sent using a first congestion control type and the second portion of data is sent using a second congestion control type.

According to a fifth aspect, there is provided a computer program comprising instructions which, when executed by at least one processor causes the at least one processor to perform the method of the first aspect.

According to a sixth aspect, there is provided a computer program comprising instructions which, when executed by at least one processor causes the at least one processor to perform the method of the third aspect.

According to a seventh aspect, there is provided a computer program product comprising a computer-readable medium having stored there on a computer program of according to the fifth aspect or the sixth aspect.

According to an eighth aspect, there is provided a carrier containing the computer program according to the fifth aspect or the sixth aspect, wherein the carrier is one of an electric signal, optical signal, an electromagnetic signal, a magnetic signal, an electric signal, radio signal, a microwave signal, or computer readable storage medium.

An advantage of the proposed technology disclosed according to some embodiments herein is that an indication whether the network load is high or low can be obtained at a node using, or connected to, the communication network. Another advantage of some embodiments is that background traffic can be delivered on the network without affecting, or at least with less effect on, the foreground traffic.

### BRIEF DESCRIPTION OF THE DRAWINGS

Examples of embodiments herein are described in more detail with reference to attached drawings in which:

FIG. 1a is a schematic block diagram illustrating a communication network with at least one node configured in accordance with one or more aspects described herein for delivering data content;

FIG. 1b is a block diagram illustrating an exemplary communication network with at least one node configured in accordance with one or more aspects described herein for delivering data content;

FIG. 2 is a flow diagram depicting processing performed by a first node for delivering data content in accordance with one or more aspects described herein;

FIG. 3 is a flow diagram depicting processing performed by a first node for delivering data content in accordance with one or more aspects described herein;

FIG. 4 is a flow diagram depicting processing performed by a second node for delivering data content in accordance with one or more aspects described herein;

FIG. 5 is a flow diagram depicting processing performed by a second node for delivering data content in accordance with one or more aspects described herein;

FIG. 6 is an exemplary flowchart depicting processing performed by a first node for delivering data content in accordance with various aspects described herein;

FIG. 7 is a further exemplary flowchart depicting processing performed by a first node for delivering data content in accordance with various aspects described herein; and

FIGS. 8-12 are illustrations of embodiments of first and second nodes, respectively, in accordance with various aspects described herein.

### DETAILED DESCRIPTION

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout. Any step or feature illustrated by dashed lines should be regarded as optional.

The technology disclosed herein relate to methods and nodes for delivering data content in a communication network from a first node to a second node. As described above, content consumption is increasing, which puts higher demand on the capacity of the mobile networks, however, the network resources available for transmitting data are not unlimited, and should therefore be used in the best way to satisfy the users' requirements. One way to achieve this is to transmit less time critical data at a time of low network load, in order to avoid such traffic interfering or competing with time critical data for the available network resources.

As an example, video delivery from a content server to a client can be done in several ways, such as streaming, or downloading. The most popular Video On Demand (VoD) video services make use of streaming, where content is downloaded in content chunks which are put in a playout buffer and are consumed within minutes by the users. It is also possible to download a whole movie or episode of a series prior to consumption. This is known as content prefetch.

Content prefetch is very popular in countries where cellular network coverage is poor, system load is continuously high, or the mobile subscription has a data bucket limit. Some operators have therefore offered users to prefetch with no redraw of their data bucket during night time when system load is low and foreground traffic, such as web browsing, Facebook, are less used.

However, the drawback with prefetch during night time is that users may have to wait many hours before the selected content is prefetch and can be viewed. Further, network operators are unwilling to have the prefetch done unless the network load is low. Network operators are also unwilling to share load information to third parties, such as a prefetch video service provider. Hence, the prefetch video service provider needs some means of their own to establish an indicator of the network load, such as the cell load, where its users are residing, and a method to avoid affecting foreground traffic performances.

Similar concerns relate to data upload from vehicles, sharing captured video, location information and status, which will increase, e.g., with self-driving cars. These may also be categorized as background traffic and have a restriction on how much effect they are allowed have on the foreground traffic.

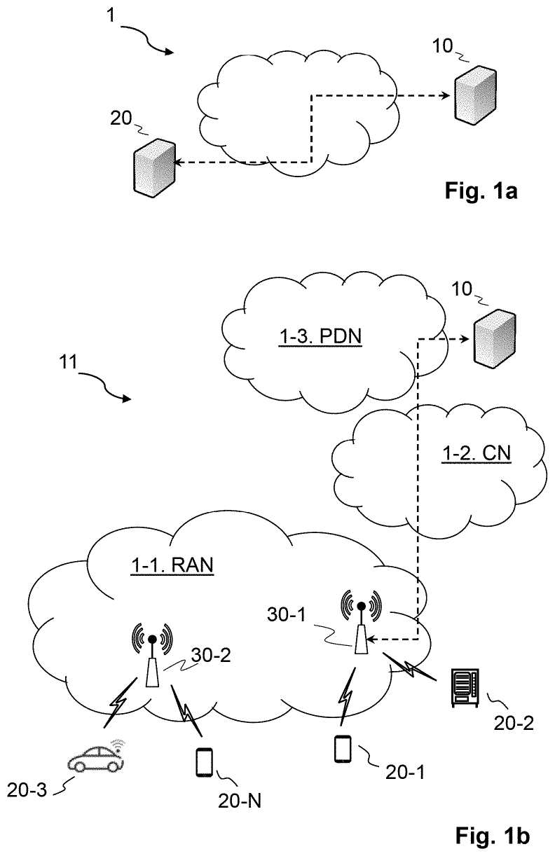

The technology presented herein relates to delivery of data content in a communication network, such as a communication network 1 as schematically illustrated in FIG. 1a. Exemplary embodiments herein may thus be implemented in the communication network 1 such as illustrated in FIG. 1. The two network nodes, first node 10 and second node 20 communicate over, or via, the communication network 1 by means of wired communication, wireless communication, or both, to deliver data content from the first node 10 to the second node 20. The communication network 1 may comprise a telecommunication network, e.g., a 5G network, an LTE network, a WCDMA network, an GSM network, or any 3^{rd} Generation Partnership Project (3GPP) cellular network, a WiMAX network, or any future cellular network. Such telecommunication network may include, e.g., a Core Network (CN) part of a cellular telecommunications network, such as a 3^{rd} Generation Partnership Project (3GPP) System Architecture Evolution (SAE) evolved packet core (EPC) network or any future cellular core network, and an Radio Access Network (RAN) part, such as UTRAN (Universal Mobile Telecommunications System (UMTS) Terrestrial Radio Access Network) or E-UTRAN (LTE Evolved UMTS Terrestrial RAN) and any future access network (such as a LTE-advanced network) that is able to communicate with a core network. The core network can, for example, communicate with a non-3GPP access network, e.g., a Wireless Local Access Network (WLAN), such as a WiFi™ (IEEE 802.11) access network, or other short range radio access networks. The telecommunication network may further provide access to a Packet Data Network (PDN), which in most cases is an IP network, e.g., Internet or an operator IP Multimedia Subsystem (IMS) service network. The core network may additionally provide access, directly or via a PDN, to one or more server networks, such as content server networks, storage networks, computational or service networks, e.g., in the form of cloud-based networks. The first node 10 and the second node 20 may hence be configured to access, connect to, or otherwise operate in, the communication network 1.

The non-limiting term User Equipment (UE) is used in some embodiments disclosed herein and it refers to any type of communications device communicating with a network node in a communications network. Examples of communications devices are wireless devices, target devices, device to device UEs, machine type UEs or UEs capable of machine to machine communication, Personal Digital Assistants (PDA), iPADs, Tablets, mobile terminals, smart phones, Laptop Embedded Equipped (LEE), Laptop Mounted Equipment (LME), USB dongles, vehicles, vending machines etc. In this disclosure the terms communications device, device and UE are used interchangeably. Further, it should be noted that the term UE used in this disclosure also covers other communications devices such as Machine Type of Communication (MTC) device, an Internet of Things (IoT) device, e.g. a Cellular IoT (CIoT) device. Note that the term user equipment used in this document also covers other devices such as Machine to Machine (M2M) devices, even though they do not have any user.

In some embodiments, the first node 10 comprises a UE as described above. Alternatively, in some embodiments, the first node 10 comprises a server, for example providing a service, such as a content server, database server, cloud server. In some further embodiments, the second node 20 comprises a UE or a server as described above. The UE can also comprise a client which is able to communicate with a server or the service provided by the server. The client and/or the service is sometimes referred to as an application, or “app”.

FIG. 1b illustrates schematically a communication network 11 in which embodiments herein may be implemented. The exemplary communication network 11 comprises a RAN 1-1, a CN 1-2, and a PDN 1-3, interconnected to allow communication between the first node 10 and any of the second nodes 20-1; 20-2; 20-3; 20-N. In this example, the second nodes 20-1; 20-2; 20-3; 20-N thus access the RAN 1-1 via at least one Access Point (AP) 30-1; 30-2, using one or more Radio Access Technology (RAT) supported by the RAN 1-1 and second nodes 20-1; 20-2; 20-3; 20-N, respectively. It will be appreciated that embodiments herein are useful for delivering data content from the first node to a second node. The AP 30-1; 30-2 may include, or be referred to, as a base station, a base transceiver station, a radio access point, an access station, a radio transceiver, Node B, an eNB, WLAN AP, or some other suitable terminology.

Methods and nodes according to some embodiments herein are advantageously used for delivering background data traffic, without affecting or at least with a reduced effect on the foreground data traffic. Foreground data traffic, or foreground traffic for short, is e.g., traffic which is delay sensitive, whereas background traffic is, e.g., traffic which is not substantially delay sensitive, or at least less sensitive to delay than foreground traffic. Alternatively, foreground traffic may be traffic which is prioritized over other traffic, why the latter may therefore be called background traffic. In general, data traffic related to speech, web browsing, gaming, Facebook, and the like, for which transmission delay negatively affects Quality of Service (QoS) and/or Quality of Experience (QoE) is in some examples considered foreground traffic.

On the other hand, in other examples, e.g., when transmitting data relating to delivery of data content, such as downloading or uploading of data files, for instance for later use, a delay in transmission can be considered acceptable, or expected, and therefore referred to as background traffic. Examples of such data content are a video file, a collection of data, or an audio book file. In some examples, such data content comprises a comparatively large amount of data in comparison to the amount of data normally associated with foreground traffic.

Throughout the present disclosure, “data content” denotes a data entity intended for carrying information between a source of data and a recipient of the data. Such data content can comprise user data, control data or even dummy data, or combinations thereof. Data content may, for example, comprise data associated with at least a part of a control signal. Data content may also, for example, comprise user data, for example, but not limited to, video, audio, image, text or document data packages. Data content may also, for example, comprise dummy data items, introduced only to meet regulation rate requirements.

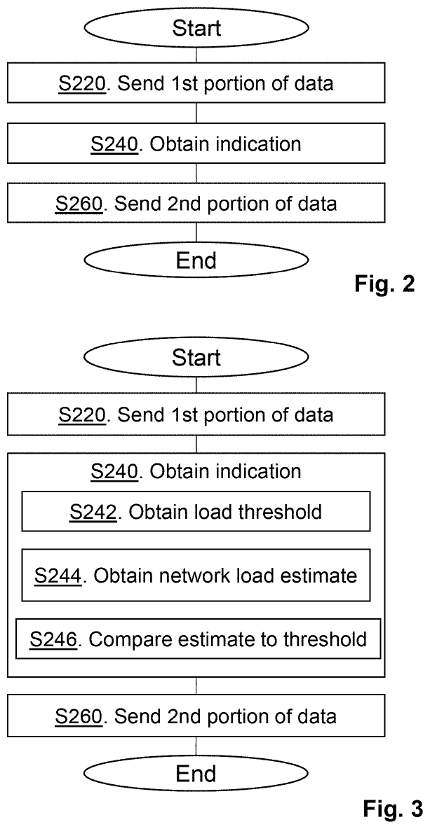

Turning now to FIG. 2, a method for delivering data content in a communication network from a first node to a second node, according to some embodiments herein is disclosed. The flow diagram depicts steps of a method performed at the first node. The data content may for example be a data file, such as a video file, an audio book file, or a file comprising a collection of information or data.

The method comprises a step S220 of sending a first portion of data of the data content to the second node. As a non-limiting example, the first portion may comprise a fraction of the data content, e.g., a fraction of a data file, and the fraction may also be substantially smaller than the complete data file. In examples where the data content comprises a video file, the first portion thus comprise a fraction of the data comprised in the complete video file. A small fraction of data may e.g. be a few seconds worth of playout data. In another example, the first portion comprises one or a limited number of, e.g., less than 10, chunks of encoded data of the video file. In these examples, the first portion of data is thus substantially smaller than the data content, i.e. the complete video file, which may be an amount of data corresponding to several minutes, or even hours of video playout. In other examples, the first portion of data is a fraction of an audio book file or a fraction of a file comprising a collection of information or data.

The method also comprises, in S240, obtaining an indication that a network congestion criteria is fulfilled, said indication being based on a comparison of a network load estimate to a load threshold. As will described below, obtaining the indication may, e.g., be obtained thru actions performed at the first node, or by receiving the indication at the first node, implying that actions have been performed at another node for providing the indication. The indication is, however, in any case based on a comparison of a network load estimate to a load threshold.

The method further comprises a step of sending S260 a second portion of data of the data content to the second node. In this step, the size or amount of data of the second portion may be larger, or even substantially larger, than in the first portion of data, e.g., several times larger than the first portion. In some embodiments, the second portion of data comprises the remaining data of the data content, e.g., the remaining part of a data file, such as a video file, an audiobook file, etc.

In this method, the first portion of data is sent using a first congestion control type and the second portion of data is sent using a second congestion control type.

Some further embodiments and more details of the technology herein will now be described.

Congestion control refers to techniques for handling congestion in communication networks, either by preventing congestion or by alleviating congestion when it occurs. Congestion leads to delays in transmission of the information, e.g., in form of data packets, sent over the network and is therefore not wanted by the network users, whether these are the providers or the users of a service, nor by the network operators. In addition to affecting the quality of the provided service, congestion also leads to further delays due to retransmissions of information and thus making the situation even worse. Congestion control is implemented by applying policies to the network traffic by means of congestion control algorithms. Several algorithms exist, each applying a particular set of policies to the traffic, e.g., how packet loss, congestion window, etc., is handled. The behavior, at least of some congestion control algorithms, can be further adjusted by the setting of congestion control parameters associated with the algorithm.

The term congestion control type as used herein, refers to a type of congestion control with which e.g. one or more specific characteristics may be associated. One exemplary characteristic may be the resulting level of aggressiveness of the data stream associated with data content being delivered over the network, when applying the particular congestion control type. For example, applying a congestion control type to data content being sent on the network, may result in the data stream associated with the data content being delivered keeps its share of the available bandwidth, even when the network load increases. A less aggressive behavior may hence be characterized by a reduction of the share of the available bandwidth when the load increases. The characteristic may alternatively be described as a tendency of the data stream to yield to another data stream having a different congestion control type, i.e., the yielding data stream backs-off when the network load increases and thereby allows more of the available bandwidth to the other, not yielding, data stream. For conciseness, this characteristic is herein expressed such that the congestion control type yields to another congestion control type. Other exemplary characteristics are how fast and how accurate the reaction to available link throughput or bandwidth is. A congestion control type may thus be a type of congestion control, associated with a particular congestion control algorithm. In a more specific example, a congestion control type may be a type of congestion control, associated with a particular congestion control algorithm having a specific congestion control parameter setting. Changing the parameter settings of a certain congestion control algorithm, may thus result in a change from one congestion control type to a different congestion control type. For example, changing the parameter settings, may result in a congestion control type with a different aggressiveness, i.e., making a congestion control type which is either more aggressive or less aggressive towards other traffic delivered on the network.

In some embodiments of the method, the first congestion control type is different from the second congestion control type. Exemplary differences will be described in more detail below.

In some embodiments, the first congestion control type yields to the second congestion control type. As described above, this characteristic behavior of the congestion control type may thus alternatively be described as the second congestion control type being more aggressive than the first congestion control type. The congestion control type may for example be associated with, e.g. be based on, a congestion control algorithm. As another example, the congestion control type may be associated with, or be based on, a congestion control algorithm associated with a specific set of congestion control parameters. As a further example, the first congestion control type may be based on a congestion control algorithm associated with a first set of congestion control parameters and the second congestion control type may be based on a congestion control algorithm associated with a second set of congestion control parameters, different from the first set of congestion control parameters. The congestion control algorithm of the first and the second congestion control type may in this latter example be the same.

In some embodiments of the method, the network load estimate is based on the sending S220 of the first portion of data. As an example, the first portion of data may have a size, e.g. comprise an amount of data, allowing an estimation of the network load to be made, based on the sending of the first portion of data.

In some further embodiments, the network load estimate is based on data throughput measurements in connection to the sending S220 of the first portion of data.

In some embodiments, the network load estimate is based on data throughput measurements in a congestion avoidance state of the first congestion control type. More particularly, the network load estimate may be based on throughput measurements in a congestion avoidance state of the congestion control algorithm with which the first congestion control type is associated.

In some embodiments, the load threshold is established based on data throughput measurements using a third congestion control type. The load threshold may optionally be established in a congestion avoidance state of the third congestion control type. More particularly, the load threshold may be based on data throughput measurements in a congestion avoidance state of the congestion control algorithm with which the third congestion control type is associated. In some examples, the third congestion control type is more aggressive than the first congestion control type, i.e., the first congestion control type yields to the third congestion control type. In addition or alternatively, a specific characteristic of the third congestion control type may be an ability to more accurately and/or quickly adapt to the available bandwidth.

The third congestion control type may in some embodiments be the same congestion control type as the second congestion control type. The specific characteristic of this, same, congestion control type is e.g. a higher level of aggressiveness than the first congestion control type, i.e., the first congestion control type yields to this congestion control type. In some examples, the third congestion control type and the second congestion control type are based on the same congestion control algorithm, and may further have the same settings of the congestion control parameters, resulting, e.g., in the above specific characteristic.

With further reference also to the schematic diagram of FIG. 1a, the load threshold may in some embodiments of the method be based on at least one of a characteristic of the communication network 1, a characteristic of the first node 10, and a characteristic of the second node 20.

The congestion criterion may for example be fulfilled when the network load estimation is less than the load threshold.

As described above, the congestion control type may be associated with a particular congestion control algorithm, sometimes referred to as congestion control mechanism. Several such algorithms exist, each having its particular behavior, although some algorithms have similar characteristics. As also mentioned, the behavior of at least some of the algorithms may be further trimmed by adjusting the setting of the congestion control parameter(s) associated with the algorithm. Two different algorithms may thus be made even further similar in their behavior, at least in some aspect(s), by such adjustment. Congestion control, in general, is applied to traffic transmitted in the communication network, wherein the transmission is often packet-based. The congestion control may be applied on the transport layer of the transmission and hence the algorithms may therefore, e.g., be implemented in the transport protocol. Implementations of one or more of the congestion control algorithms may therefore exist for transport protocols like the Transmission Control Protocol (TCP), Quick UDP Internet Connection (QUIC), to mention a few. It should be noted, however, that congestion control may alternatively, or additionally, be applied to a different layer or hierarchy of the transmission, e.g., the application layer and hence the application layer protocol, e.g., the HyperText Transfer Protocol (HTTP), the File Transfer Protocol (FTP), the Session Initiation Protocol (SIP), etc.

The characteristics of the congestion control type may hence depend on the congestion control algorithm associated therewith, which will be further described in connection with the below exemplary embodiments.

The first congestion control type may for example be associated with, or based on, one of Vegas, and Low Extra Delay Background Transport (LEDBAT). For example, the sending of the first portion of data may be the start of a prefetch of data content, e.g., a data file, such as a video file. Using a congestion control type based on either of the congestion control algorithms Vegas or LEDBAT results in the data stream associated with sending of the first the portion of data having a more pronounced yielding behavior towards other traffic. This is at least the case in some typical communication networks, in which the “other” traffic to a large extent is controlled by a more aggressive congestion control algorithm.

The second congestion control type may for example be associated with, or based on, one of Reno, Cubic, and Bottleneck Bandwidth and Round-Trip propagation Time (BBR). For example, a congestion control type based on BBR more easily and accurately follows the available bandwidth, or in other words the available link throughput. Furthermore, these congestion control algorithms are in general associated with a more aggressive behavior than the above mentioned Vegas and LEDBAT, however, the level of aggressiveness can be changed by adjusting the congestion control parameters. Hence, the sending of the second portion of data may be the continuing of the above exemplified prefetch of data content, e.g., a data file such as a video file.

The third congestion control type may for example be associated with, or based on, one of Reno, Cubic, and BBR.

In some embodiments, the data content comprises user data.

In some further embodiments, the data content comprises one of video content, audio content, and collected data. The collected data may in some examples be a collection of sensor data, such as measurement data or registrations collected over a time period from, e.g., a vehicle or a stationary device registering traffic events, or device(s) measuring environmental data, e.g. temperature, humidity, wind, seismic activity, etc. The first node may for example send such a collection of data to the second node for processing or storing.

In some embodiments of the method, the step of obtaining S240 an indication comprises receiving the indication from the second node 20.

FIG. 3 is a flow diagram depicting processing performed by a first node for delivering data content in accordance with further embodiments. Similarly to the method shown in FIG. 2, the method comprises a step S220 of sending a first portion of data of the data content to the second node and a step of sending S260 a second portion of data of the data content to the second node, wherein the first portion of data is sent using a first congestion control type and the second portion of data is sent using a second congestion control type. However, additionally the step of obtaining S240 an indication at the first node comprises the steps of obtaining S242 the load threshold, obtaining S244 the network load estimate, and comparing S246 the network load estimate to the load threshold. The obtaining S242 the load threshold may here comprise receiving the load threshold from the second node 20, or alternatively, obtaining S242 the load threshold may comprise establishing the load threshold.

The network load estimate may in some embodiments be based on data throughput measurements at the first node.

In yet other embodiments, the network load estimate is based on data throughput measurements at the second node.

As will be further described below, one or more embodiments of the above described methods may be performed by first node for sending data content in a communication network. A first node of an embodiment herein, may hence be configured to send a first portion of data of the data content to a second node, obtain an indication that a network congestion criteria is fulfilled, said indication being based on a comparison of a network load estimate to a load threshold, and further send a second portion of data of the data content to the second node. The first portion of data is sent using a first congestion control type and the second portion of data is sent using a second congestion control type. In some embodiments, to obtain the indication the first node is further configured to obtain the load threshold, obtain the network load estimate and compare the network load estimate to the load threshold. The first node may, e.g., comprise one of a user equipment or a server as described above.

FIG. 4 is a flow diagram depicting an embodiment of a method performed at a second node for delivering data content in a communication network 1 from a first node 10 to the second node 20. The method comprises in S320 receiving a first portion of data of the data content from the first node. The method also comprises, obtaining S340 an indication that a network congestion criteria is fulfilled, said indication being based on a comparison of a network load estimate to a load threshold. The method further comprises sending S360 the indication to the first node and receiving S380 a second portion of data of the data content from the first node. The first portion of data is being sent using a first congestion control type and the second portion of data being sent using a second congestion control type.

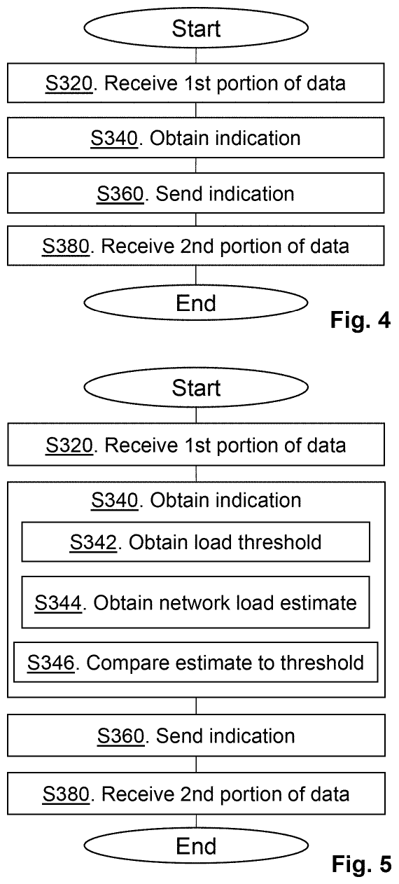

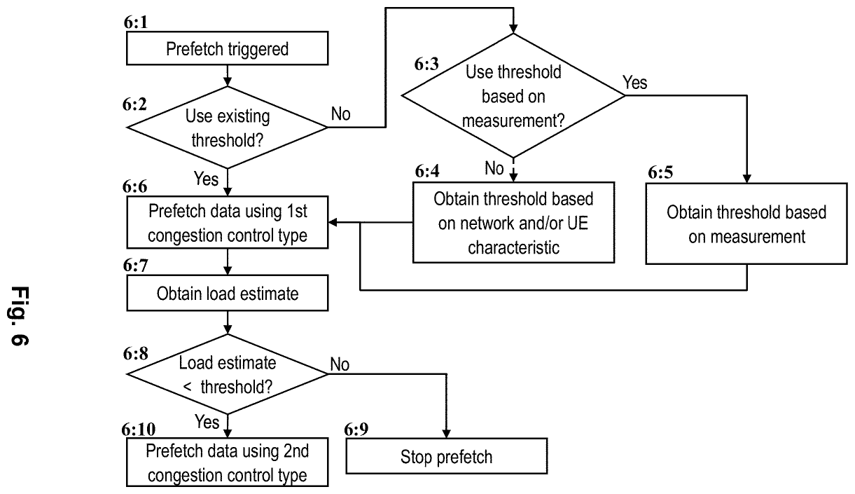

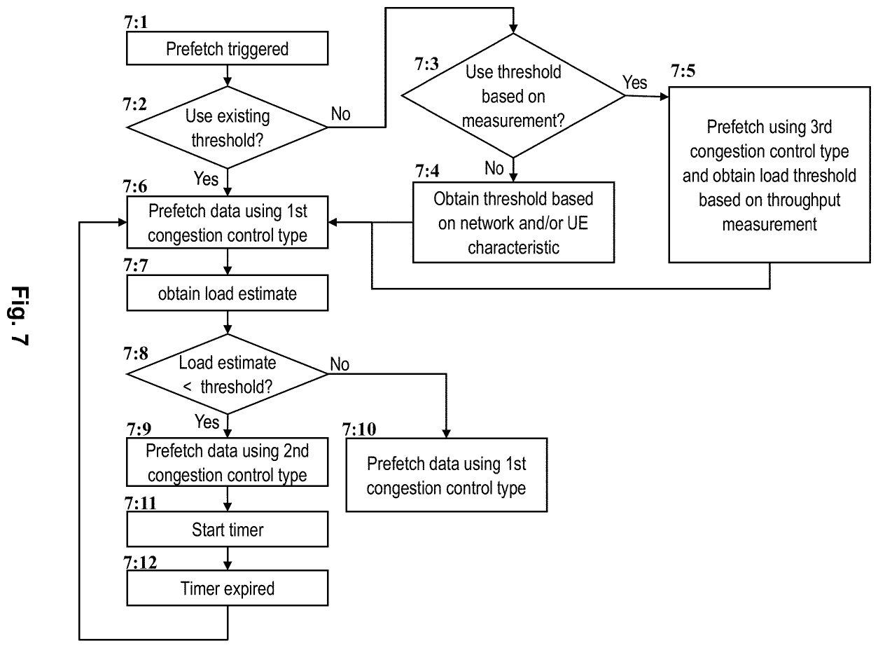

FIG. 5 is a flow diagram depicting processing performed by a second node for delivering data content from a first node to the second node in accordance with further embodiments herein. Similarly to the method shown in FIG. 4, the method comprises in step S320 receiving a first portion of data of the data content from the first node, sending S360 an indication to the first node and receiving S380 a second portion of data of the data content from the first node, wherein the first portion of data is being sent using a first congestion control type and the second portion of data being sent using a second congestion control type. In addition, the obtaining S340 an indication at the second node comprises the steps of obtaining S342 the load threshold, obtaining S344 the network load estimate, and comparing S346 the network load estimate to the load threshold.

The flowchart in FIG. 6 depicts exemplary method steps of the disclosed technology performed in a process of delivering data content from a first node to a second node. The delivery of data content is in this example a prefetch of the data content. Certain steps are performed in the first node and certain step are performed in the second node, however, some steps may be performed in either node. This exemplary method is applicable to, e.g., a case wherein a client in a first node, e.g. a UE, receives data content from a second node, e.g. a server. The method may also relate to a case wherein data content is uploaded from, e.g., a UE to a server.

6:1 The procedure starts when prefetch is triggered. The triggering is, e.g., made randomly, initiated by a user, or made when a UE enters a certain location, such as a location wherein data content previously has been downloaded. The client checks that the UE, on which it resides, has coverage, by accessing the signal strength measurement of the UE. The measurement may be accessed via the Operating System (OS) Application Programming Interface (API);

6:2 A decision is made whether to use the existing load threshold or not. For example, the existing load threshold may be too old, e.g., a stored or a received load threshold has an outdated time stamp, or should for other reasons be replaced by a new load threshold. If Yes, the procedure continues at 6:5, if No at 6:3;

6:3 A decision is made whether to use a load threshold based on throughput measurement or not. If Yes, the next step is 6:5. If No the procedure continues at 6:4;

6:4 In this step, the load threshold is obtained based either on characteristics of the communication network or the UE, or both. The characteristics may be assumed or actual characteristics of the network and/or the UE, e.g., one or more of their capabilities, capacities and usage characteristics, such as large/small load fluctuations over time, peak usage hours, UE's processing capabilities, type of OS, and movement pattern, etc.;

6:5 In this step, the load threshold is obtained based on data throughput measurements. The measurements are performed, e.g., at the node sending the data content or the receiver thereof. In this exemplary method the load threshold is based purely on data throughput measurements, however, in practice characteristics according to step 6:4, may in some cases also have to be considered;

6:6 The procedure continues by starting the prefetch of the data content, thus a first portion of data is sent from the sender to the receiver, hence in this example from the server to the UE. Advantageously the sending is performed using a congestion control type characterized by a tendency to yield to other traffic, i.e. backs off its sending rate towards other, more aggressive, data streams/flows on the network. As mentioned above examples of yielding types may be based on one of the algorithms LEDBAT and Vegas;

6:7 In this step, a network load estimate is obtained, e.g., based on the sending of the first portion of data in step 6:6. For example, a data throughput measurement may be performed, at the server or the UE (client), in connection with the sending of the first portion of data. The data throughput measurement may be done during a given period, a load estimate is thus established. As mentioned above in the disclosure, the congestion control type used for this sending is advantageously yielding to other, possibly more commonly used, congestion control types. The congestion control type based on LEDBAT congestion control algorithm can be configured with different yield settings, i.e., how strongly the prefetch data flow rate should yield to other flows. Two of these settings that affects this behavior are: a) Target for the estimated queue delay: a low target means that the prefetch flow will yield more to other flows. b) Loss event back off factor: a large back off factor means that the prefetch backs off more in the presence of packet losses;

6:8 A point decisive for the delivery of the data content has now reached. In general terms, an indication associated with the fulfillment of a network congestion criteria is obtained, wherein the indication is based on a comparison of the network load estimate to the load threshold. In this exemplary procedure, the indication is obtained at the server, e.g. by performing or receiving the result of said comparison. The network congestion criteria is here considered fulfilled when the network load estimate is less than the load threshold. As seen when the result is No, the next step is 6:9, meaning that the delivery of the data content, i.e., the prefetch in this example, may be terminated. When the result of the comparison is Yes, i.e., the network load estimate is less than the load threshold, the procedure continues at 6:10;

6:9 Prefetch is stopped. The conclusion of this may be that the chosen point in time for the prefetch was not suitable for some reason(s). The prefetched data may however be saved at the UE since further attempts to deliver the data content is likely to occur in most case;

6:10 A second portion of data of the prefetch content is sent from the server to the UE, using a second congestion control type. For example, the server may switch to the second congestion control type so that the second portion of data is sent to the UE using the second type. The second congestion control type is advantageously a type which accurately and faster follows the available bandwidth and may therefore, e.g., be based on one of the congestion control algorithms BBR, Reno and Cubic. The second portion may for example be the remaining part of the data content to be prefetched, e.g. the remaining part of a data file, such as a video file, an audio book file, etc.

The flowchart in FIG. 7 depicts a further exemplary method for delivering data content from a first node to a second node.

7:1-7:4 are similar to steps 6:1-6:4 described above;

7:5 In this step data is prefetched using a third congestion control type, having particular characteristics, such as a type which accurately and faster follows the available bandwidth. As mentioned previously, BBR is one example of a congestion control algorithm associated with these characteristics. Data throughput measurements are performed and the load threshold may be obtained by multiplying the measured throughput with a factor, e.g. a factor <1;

7:6-7:9 are similar to steps 6:6-6:9 described above;

7:10 As an alternative to stopping the prefetch when the congestion criteria is not fulfilled, e.g., the network load estimate is greater than the load threshold, it may be considered continuing the prefetch using the first congestion control type. However, when the first type yields to (most) other traffic, this may in practice only be possible when the remaining part of the data content to be prefetched is reasonably small;

7:11 When the congestion criteria is fulfilled and the second portion is delivered using a second congestion control type, an alternative to delivering the remaining part of the prefetched data content in the second portion is, to at some point, verify that the network congestion criteria is still fulfilled, e.g., that the network load has not increased significantly. In this step a timer is therefore started when the start of the prefetch using the second congestion control type;

7:12 When the timer expires, the procedure returns back to step 7:6 (see corresponding step 6:6 above) and a new network load estimate is made.

In the above examples referring to FIGS. 6 and 7, it is described that the second congestion control type may be less yielding than the first congestion control type. However, in a situation wherein the network load estimate is higher than the load threshold, an alternative to stopping the prefetch, or continuing prefetch using the first congestion control type may be to use a congestion control type yielding even more than the first congestion control type, e.g., by changing the congestion control parameters of the used congestion control algorithm or switching a different congestion control algorithm. When choosing this alternative, UE battery life and the additional load brought onto the network must be considered.

As used herein, the non-limiting term “node” may also be called a “network node”, and refer to servers or user devices, e.g., desktops, wireless devices, access points, network control nodes, and like devices exemplified above which may be subject to the data content delivery procedure as described herein.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

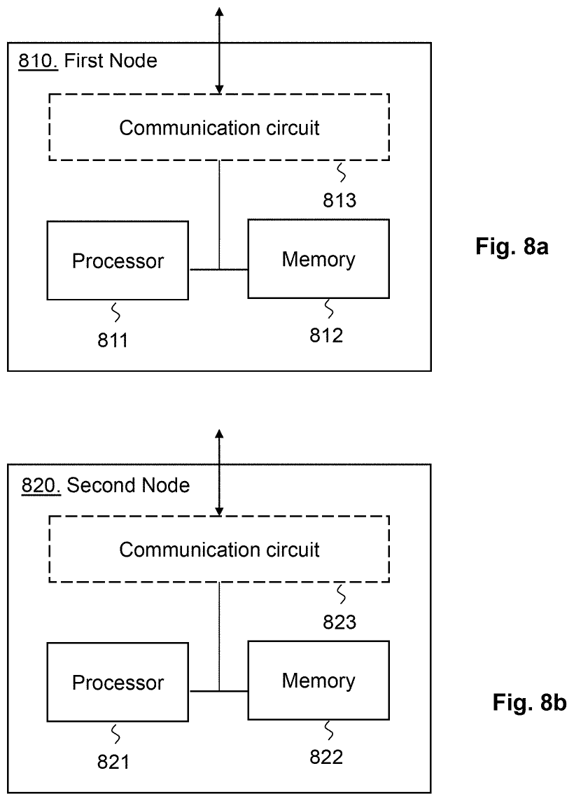

FIG. 8a is a schematic block diagram illustrating an example of a first node 810 based on a processor-memory implementation according to an embodiment. In this particular example, the first node 810 comprises a processor 811 and a memory 812, the memory 812 comprising instructions executable by the processor 811, whereby the processor is operative send a first portion of data of the data content to a second node; obtain an indication that a network congestion criteria is fulfilled, said indication being based on a comparison of a network load estimate to a load threshold; and send a second portion of data of the data content to the second node. The first portion of data is sent using a first congestion control type and the second portion of data is sent using a second congestion control type.

Optionally, the first node 810 may also include a communication circuit 813. The communication circuit 813 may include functions for wired and/or wireless communication with other devices and/or nodes in the network. In a particular example, the communication circuit 813 may be based on radio circuitry for communication with one or more other nodes, including transmitting and/or receiving information. The communication circuit 813 may be interconnected to the processor 811 and/or memory 812. By way of example, the communication circuit 813 may include any of the following: a receiver, a transmitter, a transceiver, input/output (I/O) circuitry, input port(s) and/or output port(s).

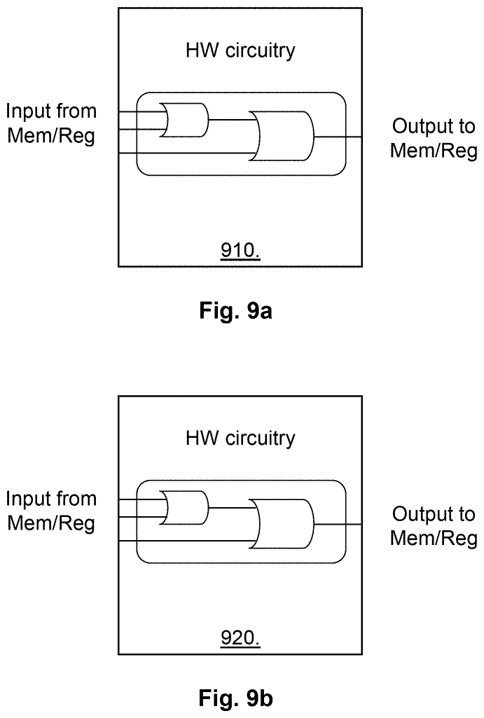

FIG. 9a is a schematic block diagram illustrating another example of a first node 910 based on a hardware circuitry implementation according to an embodiment. Examples of suitable hardware (HW) circuitry include one or more suitably configured or possibly reconfigurable electronic circuitry, e.g. Application Specific Integrated Circuits (ASICs), Field Programmable Gate Arrays (FPGAs), or any other hardware logic such as circuits based on discrete logic gates and/or flip-flops interconnected to perform specialized functions in connection with suitable registers (Reg), and/or memory units (Mem).

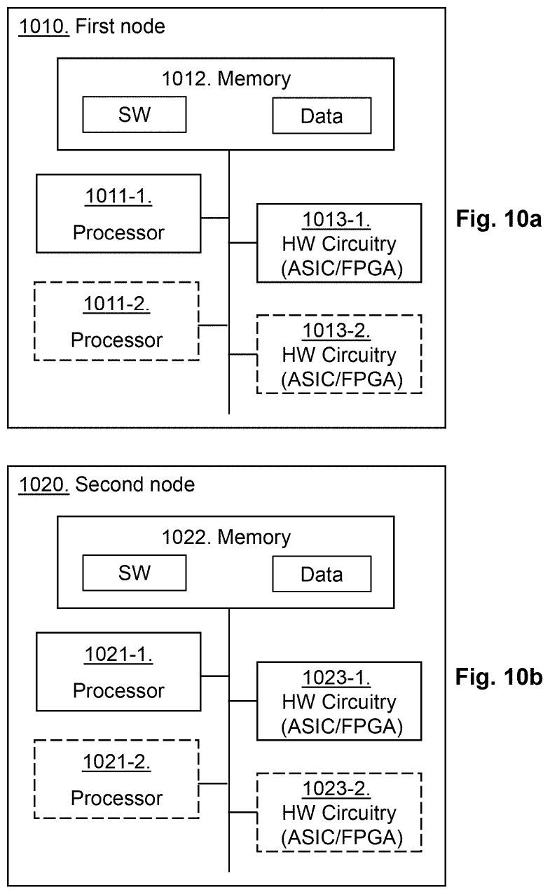

FIG. 10a is a schematic block diagram illustrating yet another example of a first node 1010, based on combination of both processor(s) 1011-1, 1011-2 and hardware circuitry 1013-1, 1013-2 in connection with suitable memory unit(s) 1012. The first node 1010 comprises one or more processors 1011-1, 1011-2, memory 1012 including storage for software and data, and one or more units of hardware circuitry 1013-1, 1013-2 such as ASICs and/or FPGAs. The overall functionality is thus partitioned between programmed software (SW) for execution on one or more processors 1011-1, 1011-2, and one or more pre-configured or possibly reconfigurable hardware circuits 1013-1, 1013-2 such as ASICs and/or FPGAs. The actual hardware-software partitioning can be decided by a system designer based on a number of factors including processing speed, cost of implementation and other requirements.

Alternatively, or as a complement, at least some of the steps, functions, procedures, modules and/or blocks described herein may be implemented in software such as a computer program for execution by suitable processing circuitry such as one or more processors or processing units.

The flow diagram or diagrams presented herein may therefore be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

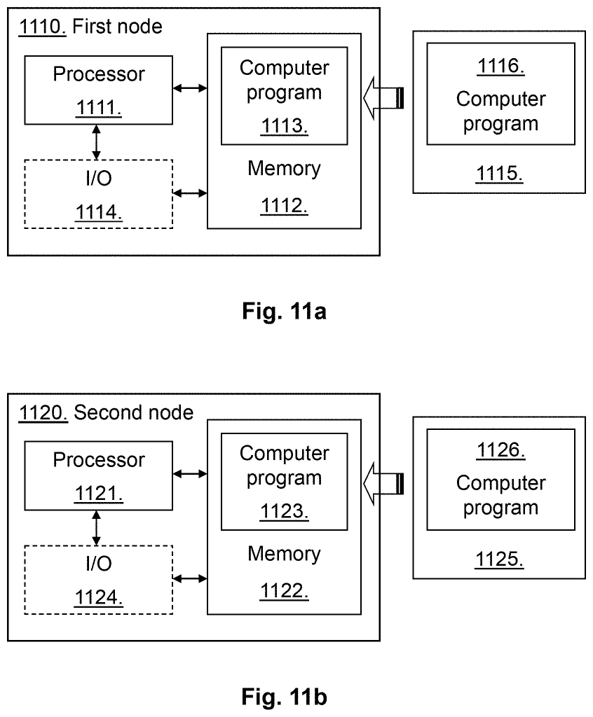

FIG. 11a is a schematic diagram illustrating an example of a computer-implementation of a first node 1110, according to an embodiment. In this particular example, at least some of the steps, functions, procedures, modules and/or blocks described herein are implemented in a computer program 1113; 1116, which is loaded into the memory 1112 for execution by processing circuitry including one or more processors 1111. The processor(s) 1111 and memory 1112 are interconnected to each other to enable normal software execution. An optional input/output device 1114 may also be interconnected to the processor(s) 1111 and/or the memory 1112 to enable input and/or output of relevant data such as input parameter(s) and/or resulting output parameter(s).

The processing circuitry including one or more processors 1111 is thus configured to perform, when executing the computer program 1113, well-defined processing tasks such as those described herein.

In a particular embodiment, the computer program 1113; 1116 comprises instructions, which when executed by at least one processor 1111, cause the processor(s) 1111 to send a first portion of data of the data content to a second node; obtain an indication that a network congestion criteria is fulfilled, said indication being based on a comparison of a network load estimate to a load threshold; and send a second portion of data of the data content to the second node. The first portion of data is sent using a first congestion control type and the second portion of data is sent using a second congestion control type.

The term ‘processor’ should be interpreted in a general sense as any system or device capable of executing program code or computer program instructions to perform a particular processing, determining or computing task.

The processing circuitry does not have to be dedicated to only execute the above-described steps, functions, procedure and/or blocks, but may also execute other tasks.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

By way of example, the software or computer program 1113; 1116 may be realized as a computer program product, which is normally carried or stored on a computer-readable medium 1112; 1115, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

The flow diagram or diagrams presented herein may be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

The computer program residing in memory may thus be organized as appropriate function modules configured to perform, when executed by the processor, at least part of the steps and/or tasks described herein.

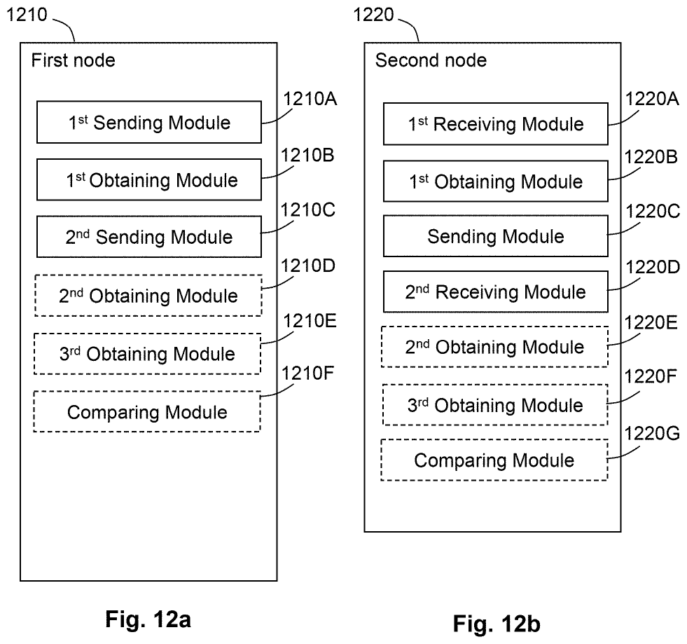

FIG. 12a is a schematic diagram illustrating an example of a first node 1210, for sending data content in a communication network, the first node comprises a first sending module 1210A for sending a first portion of data of the data content to a second node; a first obtaining module 12108 for obtaining an indication that a network congestion criteria is fulfilled, said indication being based on a comparison of a network load estimate to a load threshold; and a second sending module 1210C a second portion of data of the data content to the second node. The first portion of data is sent using a first congestion control type and the second portion of data is sent using a second congestion control type.

Optionally, the first node 1210 further comprises a second obtaining module 1210D for obtaining the load threshold; a third obtaining module 1210E for obtaining the network load estimate; and a comparing module 1210F for comparing the network load estimate to the load threshold.

Alternatively, it is possible to realize the module(s) in FIG. 12a predominantly by hardware modules, or alternatively by hardware, with suitable interconnections between relevant modules. Examples include one or more suitably configured digital signal processors and other known electronic circuits, e.g. discrete logic gates interconnected to perform a specialized function, and/or Application Specific Integrated Circuits (ASICs) as previously mentioned. Other examples of usable hardware include input/output (I/O) circuitry and/or circuitry for receiving and/or sending signals. The extent of software versus hardware is purely implementation selection.

Turning now to the second node, embodiments are described in accordance with various aspects herein.

FIG. 8b is a schematic block diagram illustrating an example of a second node 820 based on a processor-memory implementation according to an embodiment. In this particular example, the second node 820 comprises a processor 821 and a memory 822, the memory 822 comprising instructions executable by the processor 821, whereby the processor is operative receive a first portion of data of the data content from a first node; obtain an indication that a network congestion criteria is fulfilled, said indication being based on a comparison of a network load estimate to a load threshold; send the indication to the first node; and receive a second portion of data of the data content from the first node, wherein the first portion of data being sent using a first congestion control type and the second portion of data being sent using a second congestion control type.

Optionally, the second node 820 may also include a communication circuit 823. The communication circuit 823 may include functions for wired and/or wireless communication with other devices and/or nodes in the network. In a particular example, the communication circuit 823 may be based on radio circuitry for communication with one or more other nodes, including transmitting and/or receiving information. The communication circuit 823 may be interconnected to the processor 821 and/or memory 822. By way of example, the communication circuit 823 may include any of the following: a receiver, a transmitter, a transceiver, input/output (I/O) circuitry, input port(s) and/or output port(s).

FIG. 9b is a schematic block diagram illustrating another example of a second node 920 based on a hardware circuitry implementation according to an embodiment. Examples of suitable hardware (HW) circuitry include one or more suitably configured or possibly reconfigurable electronic circuitry, e.g. Application Specific Integrated Circuits (ASICs), Field Programmable Gate Arrays (FPGAs), or any other hardware logic such as circuits based on discrete logic gates and/or flip-flops interconnected to perform specialized functions in connection with suitable registers (Reg), and/or memory units (Mem).

FIG. 10b is a schematic block diagram illustrating yet another example of a second node 1020, based on combination of both processor(s) 1021-1, 1021-2 and hardware circuitry 1023-1, 1023-2 in connection with suitable memory unit(s) 1022. The second node 1020 comprises one or more processors 1021-1, 1021-2, memory 1022 including storage for software and data, and one or more units of hardware circuitry 1023-1, 1023-2 such as ASICs and/or FPGAs. The overall functionality is thus partitioned between programmed software (SW) for execution on one or more processors 1021-1, 1021-2, and one or more pre-configured or possibly reconfigurable hardware circuits 1023-1, 1023-2 such as ASICs and/or FPGAs. The actual hardware-software partitioning can be decided by a system designer based on a number of factors including processing speed, cost of implementation and other requirements.

Alternatively, or as a complement, at least some of the steps, functions, procedures, modules and/or blocks described herein may be implemented in software such as a computer program for execution by suitable processing circuitry such as one or more processors or processing units.

The flow diagram or diagrams presented herein may therefore be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

FIG. 11b is a schematic diagram illustrating an example of a computer-implementation of a second node 1120, according to an embodiment. In this particular example, at least some of the steps, functions, procedures, modules and/or blocks described herein are implemented in a computer program 1123; 1126, which is loaded into the memory 1122 for execution by processing circuitry including one or more processors 1121. The processor(s) 1121 and memory 1122 are interconnected to each other to enable normal software execution. An optional input/output device 1124 may also be interconnected to the processor(s) 1121 and/or the memory 1122 to enable input and/or output of relevant data such as input parameter(s) and/or resulting output parameter(s).

The processing circuitry including one or more processors 1121 is thus configured to perform, when executing the computer program 1123, well-defined processing tasks such as those described herein.

In a particular embodiment, the computer program 1123; 1126 comprises instructions, which when executed by at least one processor 1121, cause the processor(s) 1121 to receive a first portion of data of the data content from a first node; obtain an indication that a network congestion criteria is fulfilled, said indication being based on a comparison of a network load estimate to a load threshold; send the indication to the first node; and receive a second portion of data of the data content from the first node, wherein the first portion of data being sent using a first congestion control type and the second portion of data being sent using a second congestion control type.

The term ‘processor’ should be interpreted in a general sense as any system or device capable of executing program code or computer program instructions to perform a particular processing, determining or computing task.

The processing circuitry does not have to be dedicated to only execute the above-described steps, functions, procedure and/or blocks, but may also execute other tasks.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

By way of example, the software or computer program 1123; 1126 may be realized as a computer program product, which is normally carried or stored on a computer-readable medium 1122; 1125, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

The flow diagram or diagrams presented herein may be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

The computer program residing in memory may thus be organized as appropriate function modules configured to perform, when executed by the processor, at least part of the steps and/or tasks described herein.

FIG. 12b is a schematic diagram illustrating an example of a second node 1220, for receiving data content. The second node comprises a receiving module 1220A for receiving a first portion of data of the data content from a first node. The second node further comprises a first obtaining module 1220B for obtaining an indication that a network congestion criteria is fulfilled, said indication being based on a comparison of a network load estimate to a load threshold. The second node further comprises a sending module 1220C for sending the indication to the first node. The second node also comprises a second receiving module 1220D for a second portion of data of the data content from the first node. The first portion of data is sent using a first congestion control type and the second portion of data being sent using a second congestion control type

Optionally, the second node 1220 further comprises a second obtaining module 1220E for obtaining the load threshold and a third obtaining module 1220F for obtaining the network load estimate. The second node may further comprise a comparing module 1220G for comparing the network load estimate to the load threshold.

Alternatively, it is possible to realize the module(s) in FIG. 12b predominantly by hardware modules, or alternatively by hardware, with suitable interconnections between relevant modules. Examples include one or more suitably configured digital signal processors and other known electronic circuits, e.g. discrete logic gates interconnected to perform a specialized function, and/or Application Specific Integrated Circuits (ASICs) as previously mentioned. Other examples of usable hardware include input/output (I/O) circuitry and/or circuitry for receiving and/or sending signals. The extent of software versus hardware is purely implementation selection.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

1. A method for delivering data content in a communication network from a first node to a second node, the method comprising at the first node:
sending a first portion of data of the data content to the second node;
obtaining an indication that a network congestion criteria is fulfilled, said indication being based on a comparison of a network load estimate to a load threshold; and
sending a second portion of data of the data content to the second node, wherein the first portion of data is sent using a first congestion control type and the second portion of data is sent using a second congestion control type.

2. The method according to claim 1, wherein the first congestion control type yields to the second congestion control type.

3. The method according to claim 1, wherein the network load estimate is based on the sending of the first portion of data.

4. The method according to claim 1, wherein the network load estimate is based on data throughput measurements in connection to the sending of the first portion of data.

5. The method according to claim 1, wherein the network load estimate is based on data throughput measurements in a congestion avoidance state of the first congestion control type.

6. The method according to claim 1, wherein the load threshold is established based on data throughput measurements using a third congestion control type.

7. The method according to claim 6, wherein the load threshold is established in a congestion avoidance state of the third congestion control type.

8. The method according to claim 6, wherein the third congestion control type is the same type as the second congestion control type.

9. The method according to claim 1, wherein the load threshold is based on at least one of a characteristic of the communication network, a characteristic of the first node, and a characteristic of the second node.

10. The method according to claim 1, wherein the congestion criterion is fulfilled when the network load estimation is less than the load threshold.

11. The method according to claim 1, wherein the first congestion control type is associated with one of Vegas, and Low Extra Delay Background Transport, LEDBAT.

12. The method according to claim 1, wherein the second congestion control type is associated with one of Reno, Cubic, and Bottleneck Bandwidth and Roundtrip propagation time, BBR.

13. The method according to claim 6, wherein the third congestion control type is associated with one of Reno, Cubic, and BBR.

14. The method according to claim 1, wherein the data content comprises a user data.

15. The method according to claim 1, wherein the data content comprises one of video content, audio content, and collected data.

16. The method according to claim 1, wherein obtaining an indication comprises receiving the indication from the second node.

17. The method according to claim 1, wherein obtaining an indication comprises:
obtaining the load threshold;
obtaining the network load estimate; and
comparing the network load estimate to the load threshold.

18. The method according to claim 17, wherein the obtaining the load threshold comprises:
receiving the load threshold from the second node.

19. The method according to claim 17, wherein the obtaining the load threshold comprises establishing the load threshold.

20. The method according to claim 1, wherein the network load estimate is based on data throughput measurements at the first node.

21. The method according to claim 1, wherein the network load estimate is based on data throughput measurements at the second node.

22. A first node for sending data content in a communication network, the first node configured to:
send a first portion of data of the data content to a second node;
obtain an indication that a network congestion criteria is fulfilled, said indication being based on a comparison of a network load estimate to a load threshold; and
send a second portion of data of the data content to the second node, wherein the first portion of data is sent using a first congestion control type and the second portion of data is sent using a second congestion control type.

23. The first node according to claim 22, wherein to obtain the indication the first node is further configured to:
obtain the load threshold;
obtain the network load estimate; and
compare the network load estimate to the load threshold.

24. The first node according to claim 22, wherein the first node comprises one of a user equipment, a machine-to-machine device, and a vehicle.

25. A first node for sending data content in a communication network, the first node comprising:
a first sending module for sending a first portion of data of the data content to a second node;
a first obtaining module for obtaining an indication that a network congestion criteria is fulfilled, said indication being based on a comparison of a network load estimate to a load threshold; and
a second sending module a second portion of data of the data content to the second node, wherein the first portion of data is sent using a first congestion control type and the second portion of data is sent using a second congestion control type.

26. The first node according to claim 25, further comprising:
a second obtaining module for obtaining the load threshold;
a third obtaining module for obtaining the network load estimate; and
a comparing module for comparing the network load estimate to the load threshold.

27. A method for delivering data content in a communication network from a first node to a second node, the method comprising at the second node:
receiving a first portion of data of the data content from the first node;
obtaining an indication that a network congestion criteria is fulfilled, said indication being based on a comparison of a network load estimate to a load threshold;
sending the indication to the first node; and
receiving a second portion of data of the data content from the first node, wherein the first portion of data being sent using a first congestion control type and the second portion of data being sent using a second congestion control type.

28. The method according to claim 27, wherein obtaining an indication comprises:
obtaining the load threshold;
obtaining the network load estimate; and
comparing the network load estimate to the load threshold.

29. A second node for receiving data content in a communication network, the second node configured to:
receive a first portion of data of the data content from a first node;
obtain an indication that a network congestion criteria is fulfilled, said indication being based on a comparison of a network load estimate to a load threshold;
send the indication to the first node; and
receive a second portion of data of the data content from the first node, wherein the first portion of data being sent using a first congestion control type and the second portion of data being sent using a second congestion control type.

30. The second node according to claim 29, wherein to obtain the indication the second node is further configured to:
obtain the load threshold;
obtain the network load estimate; and
compare the network load estimate to the load threshold.

31. A second node for receiving data content in a communication network from a first node, the second node comprising:
a first receiving module for receiving a first portion of data of the data content from the first node;
a first obtaining module for obtaining an indication that a network congestion criteria is fulfilled, said indication being based on a comparison of a network load estimate to a load threshold;
a sending module for sending the indication to the first node; and
a second receiving module for receiving a second portion of data of the data content from the first node, wherein the first portion of data being sent using a first congestion control type and the second portion of data being sent using a second congestion control type.

32. The second node according to claim 31, further comprising:
a second obtaining module for obtaining the load threshold;
a third obtaining module for obtaining the network load estimate; and
a comparing module for comparing the network load estimate to the load threshold.

33. A computer program comprising instructions which, when executed by at least one processor cause the at least one processor to perform the method according to claim 1.

34. A computer program product comprising a computer-readable medium having stored there on a computer program of claim 33.

35. A carrier comprising the computer program of claim 33, wherein the carrier is one of an electronic signal, an optical signal, an electromagnetic signal, a magnetic signal, an electric signal, a radio signal, a microwave signal, or a computer-readable storage medium.

36. A computer program comprising instructions which, when executed by at least one processor cause the at least one processor to perform the method according to claim 27.

37. A computer program product comprising a computer-readable medium having stored there on a computer program of claim 36.

38. A carrier comprising the computer program of claim 36, wherein the carrier is one of an electronic signal, an optical signal, an electromagnetic signal, a magnetic signal, an electric signal, a radio signal, a microwave signal, or a computer-readable storage medium.
